(19) United States
(12) Patent Application Publication
(10) Pub. No.: US 2009/0097188 A1
(43) Pub. Date: Apr. 16, 2009

(54) Carbon Surface Modifications

(75) Inventor: Porter Mitchell, San Diego, CA (US)

Correspondence Address: MAXWELL TECHNOLOGIES, INC., 9244 BALBOA AVENUE, SAN DIEGO, CA, 92123, US

(73) Assignee: MAXWELL TECHNOLOGIES, INC., San Diego, CA (US)

(21) Appl. No.: 11/871,080

(22) Filed: Oct. 11, 2007

(51) Int. Cl. C09C 1/44; B01J 19/08; H01G 9/155

(52) U.S. Cl. 361/502; 422/186; 423/414; 423/415.1

(57) ABSTRACT

Electrode material typically is made from treated carbons. The number of functional groups residing on the treated carbon is reduced before the treated carbon is integrated into an electrochemical double layer capacitor. In one implementation, the number of functional groups on a given treated carbon is reduced by over 80%.

### BACKGROUND

The following description is provided to assist the understanding of the reader. None of the information provided or references cited are admitted to be prior art to the present invention.

Electrodes are widely used in many devices that store electrical energy, including primary (non-rechargeable) battery cells, secondary (rechargeable) battery cells, fuel cells, and capacitors. Important characteristics of electrical energy storage devices include energy density, power density, maximum charging rate, internal leakage current, equivalent series resistance, and/or durability, i.e., the ability to withstand multiple charge-discharge cycles. For a number of reasons, double layer capacitors, also known as supercapacitors or ultracapacitors, are gaining popularity in many energy storage applications. The reasons include availability of double layer capacitors with high power densities (in both charge and discharge modes), and with energy densities now approaching those of conventional rechargeable cells.

When electric potential is applied between a pair of electrodes of a double layer capacitor, ions that exist within the electrolyte are electrostatically attracted to the surfaces of the oppositely-charged electrodes, and migrate towards the electrodes. A layer of oppositely-charged ions is thus created and maintained near each electrode surface. Electrical energy is stored in the charge separation layers between these ionic layers and the charge layers of the corresponding electrode surfaces. Electrostatic energy can also be stored in the double layer capacitors through orientation and alignment of molecules of the electrolytic solution under influence of the electric field induced by the potential.

In comparison to conventional capacitors, double layer capacitors have high capacitance in relation to their volume and weight. There are two main reasons for these volumetric and weight efficiencies. First, the charge separation layers are very narrow. Their widths are typically on the order of nanometers. Second, the electrodes can be made from a porous material, providing very large effective surface area per unit volume. Because capacitance is directly proportional to the electrode area and inversely proportional to the widths of the charge separation layers, the combined effect of the large effective surface area and narrow charge separation layers is capacitance that is very high in comparison to that of conventional capacitors of similar size and weight.

The power output of a given capacitor is calculated by the following equation:

Pₐᵥ=E/t Equation 1:

where Pₐᵥ is the power output of the capacitor, E represents the stored electrical energy within the capacitor, and t represents time. Since power and electrical energy are proportional, then maximizing the energy storage capability of a capacitor also maximizes the possible power output of the capacitor over a given time period. Electrical energy stored in a capacitor is determined using a well-known formula:

E=CV²/2 Equation 2:

In this formula, E again represents the stored energy, C stands for the capacitance, and V is the voltage of the charged capacitor. It follows that a capacitor's energy storage capability depends on both (1) its capacitance, and (2) its voltage. Increasing these two parameters may therefore be important to capacitor performance.

During operation of a double layer capacitor, the capacitor experiences a number of charge-discharge cycles. A cycle occurs when voltage is applied across the capacitor and then flushed out of the capacitor. With every cycle applied to a given capacitor, the capacitor experiences a reduction in rated capacitance. As seen in both Equation 1 and Equation 2 above, if the capacitance (C) is decreased, then the energy and the power output are likewise decreased. It then becomes apparent that improved techniques and methods are needed to maintain or control the depletion of the rated capacitance of a given capacitor. Controlling the capacitance fade enables control and maintenance of the energy and power outputs from the capacitor. It is thus desirable to improve reliability and durability of double layer capacitors, as measured by the number of charge-discharge cycles that a double layer capacitor can withstand without significant deterioration in its operating characteristics.

### BRIEF SUMMARY

Implementations provided are directed to treated carbon, electrodes made from the treated carbon, electrical devices, methods of manufacture therefore, and an apparatus for treating carbon. One implementation is a method of treating carbon for use in electrodes. In accordance with such a method, activated carbon is exposed to microwave energy to reduce the number of functional groups residing on the carbon.

Thus, one implementation provides a method of making treated carbon, where the method comprises providing a carbon sample; flowing a reactant gas over the carbon sample; heating the carbon sample to at least 300° C.; and targeting the carbon sample with microwave energy at or about ambient pressure, and in some instances, pressures greater than ambient pressure. In certain implementations, the reactant gas comprises hydrogen and nitrogen, and in certain implementations the percentage of hydrogen in the reactant gas is between 1% and 20%, between 3% and 10%, or between 4% and 8%. In yet other implementations, the reactant gas further comprises methane and a non-reactive gas such as argon is flowed into the reaction chamber as well. Additionally, in certain implementations the reactant gas is provided in a continuous flow stream. In other implementations of this aspect, the carbon sample is heated to at least 500° C., or to at least 600° C., or to at least 1000° C., and the exposing step lasts for less than about 30 minutes, 15 minutes, 10 minutes, or for about 5 minutes. In addition, the method may include microwave energy supplied a frequency of at least 0.3 GHz, with frequencies centered around 0.915, 2.45, 5.80, or 22.0 GHz being presently preferred in North America; particularly frequencies centered around 0.915, 2.45, or 5.80 GHz; especially frequencies centered around 0.915 or 2.45 GHz.

A power level of the microwave energy may be dependent on the amount of carbon being treated. In one implementation, for example, a power range of about 300 to 1500 Watts could be used for one quantity of carbon. In another implementation, for example, a power range of about 3 to 10 kW or more could be used depending on the quantity of carbon being treated in a reaction zone, a depth of penetration of the energy into the carbon, and the amount of reflected energy. When microwave radiation enters the reaction zone, it either adsorbs into the carbon being treated or is reflected back to the magnetron and is wasted and can even damage the magnetron.

Further, the method of making treated carbon may include a step where the carbon sample is degassed before the flowing, heating and exposing steps. The degassing step, for example, may be performed at a temperature of between about 80 and 200° C. or at a temperature of between about 100 and 150° C. In some implementations of the degassing step, it is performed under continuous vacuum while sparging the reaction chamber with a small (e.g., 1 to 100 SCCM (standard cubic centimeters per minute)) flow rate of nitrogen gas at about 15-29.9 inches Hg or at about 25-29.9 inches Hg or at about 28 inches Hg.

Implementations herein further include an electrochemical double layer capacitor comprising a first electrode; a second electrode; a porous separator disposed between the first and second electrode; a container; and an electrolyte; wherein the first and second electrodes comprise treated carbon manufactured by providing a carbon sample; flowing a reactant gas over the carbon sample; heating the carbon sample to at least 300° C.; and targeting the carbon sample with microwave energy at or about ambient pressure, and in some instances, greater than ambient pressure.

In addition, implementations herein further include a treated carbon with reduced oxygen-containing functional groups formed by: providing a carbon sample; flowing a reactant gas over the carbon sample; heating the carbon sample to at least 300° C.; and targeting the carbon sample with microwave energy at or about ambient, and in some instances, greater than ambient pressure.

Other applications for such a treated carbon material include, but are not limited to, ultracapacitor or fuel cell electrodes, water purification (desalinization), recovery of precious metals (e.g., treat carbon for affinity to a particular ion, such as gold), and indication for adsorption properties.

These and other features and aspects will be better understood with reference to the following description, drawings and appended claims.

### BRIEF DESCRIPTION OF THE DRAWINGS

The invention is best understood from the following Detailed Description describing various implementations read in connection with the accompanying drawings.

FIG. 1, which includes sub-part FIGS. 1A and 1B, illustrates a cross-section of exemplary electrode assemblies which may be used in a double layer capacitor.

FIG. 2, is a block diagram showing an example of a system for treating carbon material.

FIG. 3 is data chart of the comparative percent reduction of functional groups for carbon samples under different exposure conditions.

FIG. 4 is a graph of the capacitance fade of a single capacitor when exposed to constant current cycling at 3V with a 15 second rest between a charge-discharge cycle.

FIGS. 5A to 5C are data charts of the relative element surface composition of different carbon materials treated with microwave energy.

FIG. 6 is a graph of the comparative internal pressure rise within a capacitor when microwave-treated and -untreated carbon is used in a capacitor.

### DETAILED DESCRIPTION

In this document, the words “implementation” and “variant” may be used to refer to a particular apparatus, process, or article of manufacture, and not necessarily always to one and the same apparatus, process, or article of manufacture. Thus, “one implementation” (or a similar expression) used in one place or context can refer to one particular apparatus, process, or article of manufacture; and, the same or a similar expression in a different place can refer either to the same or to a different apparatus, process, or article of manufacture. Similarly, “some implementations,” “certain implementations,” or similar expressions used in one place or context may refer to one or more particular apparatuses, processes, or articles of manufacture; the same or similar expressions in a different place or context may refer to the same or a different apparatus, process, or article of manufacture. The expression “alternative implementation” and similar phrases are used to indicate one of a number of different possible implementations. The number of possible implementations is not necessarily limited to two or any other quantity. Characterization of an implementation as “an exemplar” or “exemplary” means that the implementation is used as an example. Such characterization does not necessarily mean that the implementation is a preferred implementation; the implementation may but need not be a currently preferred implementation.

The following description is not to be taken in the limiting sense, but is made merely for the purpose of describing the general principles of the invention. The scope of the invention should be determined with reference to the claims.

High-capacitance double layer capacitors use high surface area carbons to store energy through charge separation. The high surface areas on the carbon are created through a process of chemical and/or thermal oxidative processes. The incomplete oxidation of the carbon creates oxygen-containing functional groups on the carbon surface including carboxyl, carboxylate, hydroxyl, lactone, quinone and phenols. The residual oxygen contributes to deleterious performance properties of capacitors including capacitance fade on cycling, self discharge, pseudocapacity, gas formation at high potential voltages and increased hydrophilic surface properties which stimulate moisture adsorption. Manufacturers of carbon for capacitors and other energy storage devices seek to minimize the residual oxygen content through modified activation process conditions and post-activation thermal treatments. Additional activation treatments and post-thermal processes to remove or minimize the residual oxygen adds material, process and energy costs to the total cost of the activated carbon.

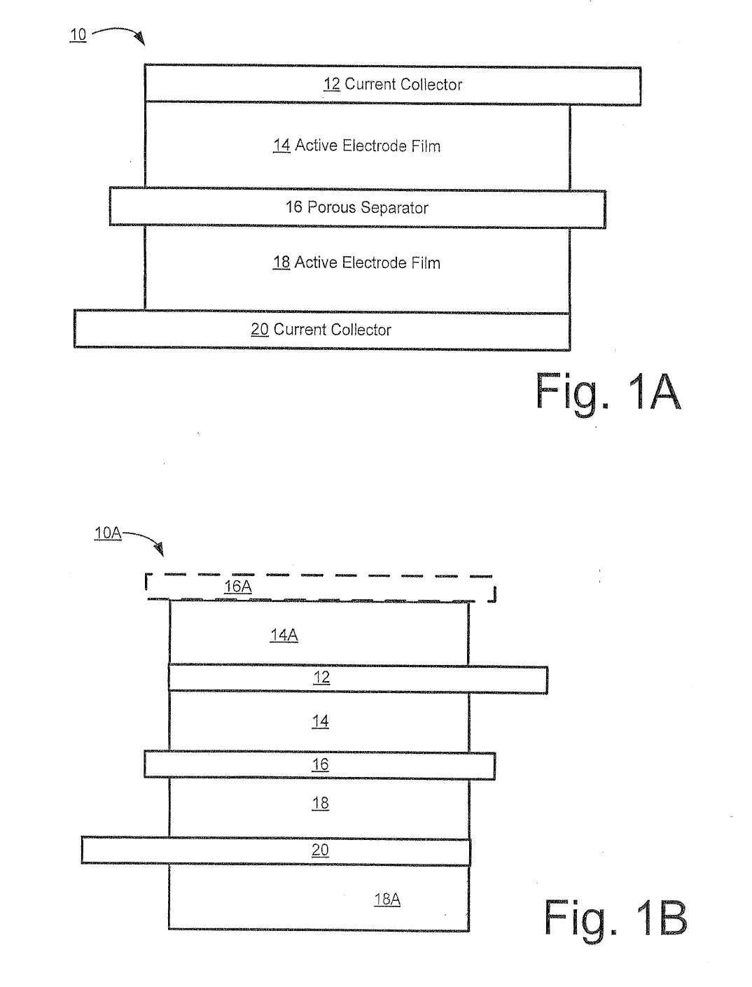

An example of a double layer capacitor electrode 10 is shown in FIG. 1, including sub-part FIGS. 1A and 1B, illustrates, in a high level manner, respective cross-sectional views of an electrode assembly 10 which may be used in an ultracapacitor or a double layer capacitor. In FIG. 1A, for example, the components of the assembly 10 are arranged in the following order: a first current collector 12, a first active electrode film 14, a porous separator 16, a second active electrode film 18, and a second current collector 20. In some implementations, a conductive adhesive layer (not shown) may be disposed on current collector 12 prior to bonding of the electrode film 14 (or likewise on collector 20 relative to film 18).

In FIG. 1B, a double layer of films 14 and 14A are shown relative to collector 12, and a double layer 18, 18A relative to collector 18. In this way, a double-layer capacitor may be formed, i.e., with each current collector having a carbon film attached to both sides. A further porous separator 16A may then also be included, particularly for a jellyroll application, the porous separator 16A either attached to or otherwise disposed adjacent the top film 14A, as shown, or to or adjacent the bottom film 18A (not shown). The films 14 and 18 (and 14A and 18A, if used) may be made using particles of treated active electrode material.

An exemplary double layer capacitor using the electrode assembly 10 may further include an electrolyte and a container, for example, a sealed can, that holds the electrolyte. The assembly 10 may be disposed within the container (can) and immersed in the electrolyte. In many implementations, the current collectors 12 and 20 may be made from aluminum foil, the porous separator 16 may be made from one or more ceramics, paper, polymers, polymer fibers, glass fibers, and the electrolytic solution may include in some examples, 1.5 M tetramethylammonium tetrafluroborate in organic solutions, such as PC or Acetronitrile solvent. Alternative electrolyte examples are known in the art.

Currently marketed carbons used for energy storage device electrodes possess several oxygen-containing functional groups over the surface area of the carbon material. One implementation is a method for reducing the number of functional groups from activated carbon. Activated carbons are formulated to possess not only optimum physical properties (e.g., surface area, porosity, pore size distribution, hardness), but also optimum chemical properties. Functional group reduction may be achieved through numerous processes including chemical treatment, electrochemical treatment, and thermal treatment. The principal production method for functional group reduction is thermal treatment.

Thermal treatment of carbons in different gaseous environments is used for eliminating oxygen-containing functional groups from the carbon surface, resulting in carbon samples with low oxygen content yet maintaining basic properties, such as surface area, pore volume and pore size. The greatest disadvantage in utilizing thermal treatment of carbon is that such treatments must be carried out at high temperatures (e.g., greater than 600° C.) in the presence of an inert or reducing gas or at high vacuums for long periods of time (e.g., four to twelve hours or more). Such extended times of indirect heating of the carbon is inefficient and substantially increases the cost of the carbon.

Microwave treatment in an inert environment provides an efficient way of removing oxygenated functionalities from carbon surfaces. Depending on the characteristics of the carbon sample and the treatment system used, microwave-induced treatment can remove most of the oxygen-containing surface groups in a matter of minutes. Further, advantages of microwave treatment of carbon include: (1) reducing the initial rate of capacity loss, (2) increasing the number of C═C bond formation, (3) maintaining particle size, pore size, and pore volume thereby maintaining the available surface area for capacitance, and (4) providing surface chemistry characteristics (i.e, reduced oxygen containing functional groups) comparable to conventional thermally treated carbon. Moreover, implementations of proposed methods can be carried out at or about atmospheric pressure or greater, eliminating the need for maintaining a vacuum environment during processing. Further, processing times of less than thirty minutes, such as about 5 minutes, can be achieved. Thus, the proposed methods may be carried out quickly in a reaction chamber that does not require a vacuum making the reaction chamber and method cost effective, time saving, easy to perform and scaleable for production volumes.

Differences between conventional methods of heating and microwave heating include the way in which heat is generated. In conventional approaches, the heat source is located outside the carbon bed, and the bed is heated by conduction and/or convection. A temperature gradient is established in the material until conditions of steady state are reached.

In a microwave method, however, electromagnetic radiation energy is absorbed by the carbon particles. The heat is generated in the particles irradiated with microwaves by either orientation polarization or equivalent resistance heating. The operative mechanism is dependent upon the operating frequency. Using 2.45 GHz frequency, it is anticipated that the orientation polarization is the most important mechanism heating the carbon particles; as opposed to equivalent resistance heating which results from the flow of conductive current in the substance and normally is more significant at lower microwave frequencies. The current resulting from equivalent resistance heating is related to electronic conduction and ionic conduction in a material. Equivalent resistance heating is more significant at lower frequencies.

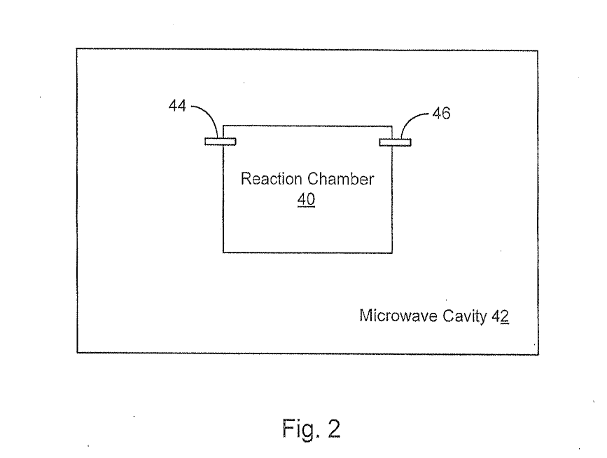

In one implementation, a carbon sample is placed into a reaction chamber 40, such as a quartz reactor, which in turn is placed inside a microwave cavity 42 as shown in FIG. 2. The carbon sample is first dried and degassed using an inert gaseous flow (100 SCCM N₂), which may be delivered via a gas inlet 44 and a gas outlet 46, in a vacuum atmosphere. Next, a reactant gas flow, containing H₂ in some proportion, is run through the quartz reactor. Then, the carbon sample is subjected to microwave energy for less than about 30 minutes with a sample temperature in the range of about 300° C. to 1000° C., all at or about ambient pressure (that is, at atmospheric pressure) or in some instances, pressures greater than ambient pressure. Finally, the carbon sample is cooled to room temperature.

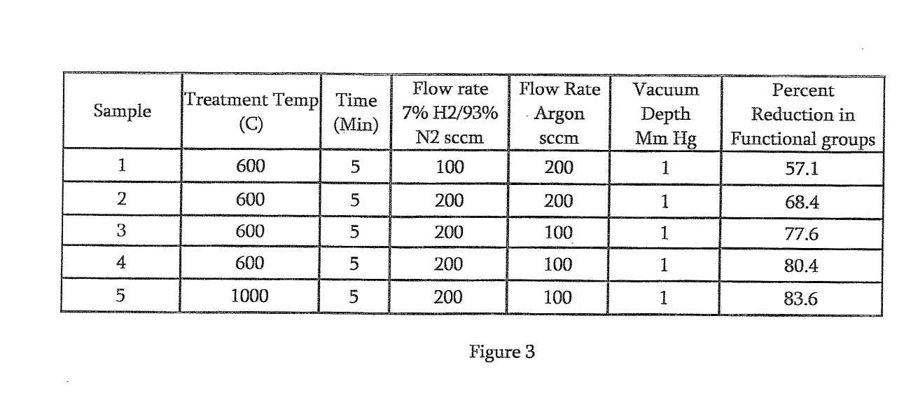

FIG. 3 is a summary of data showing percent reduction in functional groups for carbon samples treated under various conditions. Treating carbon samples at either 600° C. or 1000° C. for 5 minutes in a 7% H₂/93% N₂ gas at a flow rate of either 100 or 200 SCCM at atmospheric pressure resulted in a reduction of oxygen-containing functional groups from over 50% to over 80%. The final conditions chosen for further studies were 600° C. for 5 minutes, 200 SCCM 7% H₂/93% N₂ at atmospheric pressure and with a 10 minute degassing at 28 inches Hg, 100-150° C., with 100 SCCM N₂.

Conditions amenable to reducing functional groups in such microwave treatments include using a reactant gas mixture comprising hydrogen and nitrogen, where the hydrogen comprises about 1% to 20% of the reactant gas, or between 3% and 10% of the reactant gas, or between 4% and 8% of the reactant gas, or between about 5% to about 7% of the reactant gas. In addition, the reactant gas may comprise methane, ammonia, or syngas (also called synthesis gas which is 1/1 molar CO/H₂). The flow rate of the reactant, for example, gas may be between about 70-300 SCCM, or between about 100-250 SCCM, or between about 150-220 SCCM. In addition, argon or another unreactive gas, such as, nitrogen or helium, may be flowed into the reaction chamber at about 70-300 SCCM, or at about 100-200 SCCM.

Temperatures for processing are over 300° C., and are typically above about 500° C., and may be as high as 600° C. or 1000° C. It is advantageous to be able to use lower temperatures and ambient pressure, as these factors contribute to easier and less costly processing.

Additionally, the times for processing the carbon samples can be short, which again contributes to easier and less costly processing. The times, for example, can be less than about 30 minutes, or less than about 15 or 10 minutes, and can be as short as 5 minutes. Processing time will differ from reactor to reactor depending on the size of the carbon sample, and the power available in the reactor. For example, the power supplied may range from 300-1500 Watts. A carbon sample might need to be processed for more than 15 minutes in 300 Watt processor, where 5 minutes is adequate in a 1000 Watt processor.

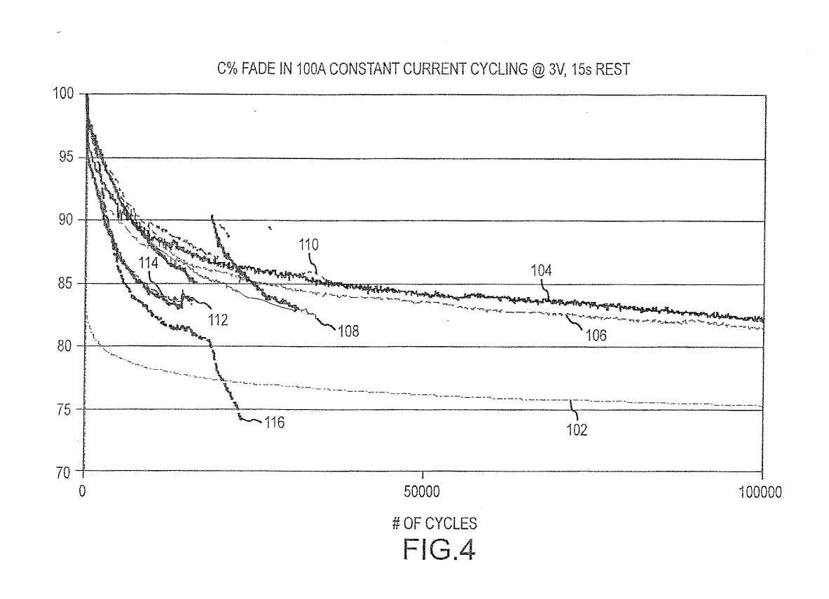

The removal of oxygen-containing functional groups from carbon positively impacts the durability of a capacitor. As stated above, with each charge-discharge a capacitor experiences, the capacitance of the capacitor fades. Capacitors containing microwave treated carbon with a reduced number of functional groups demonstrated a decrease in capacitance fade. FIG. 4 shows the results of capacitance fade in 100 Amp constant current cycling at 3 Volts with 15 seconds rest. Various carbon samples were formulated with carbon black and PTFE. The powder was calendered into a film, then laminated to aluminum foil. The electrodes were then wound into 2600 F ultracapacitor cells. The lower line 102 is the prediction of a two million cycle life using a standard carbon electrode capacitor. The upper line 104 and line 106 show the results for capacitors built with ultra-pure, non-commercially available carbon. The line 108 and the line 110 are the results for microwave treated carbon samples, and the line 112, line 114 and line 116 show the results for various untreated samples. The microwave-treated carbon samples produced capacitors capable of experiencing more charge-discharge cycles before failure, leading to a longer capacitor lifetime.

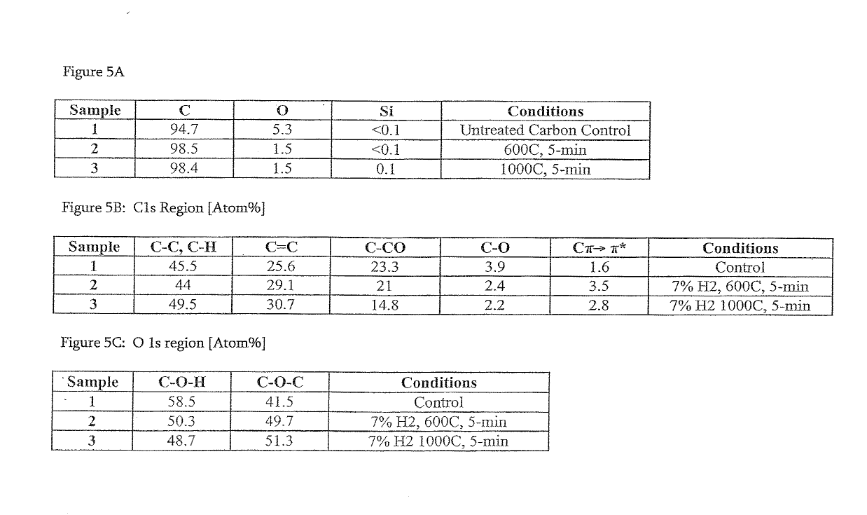

FIG. 5A shows the relative element surface composition as determined by X-ray photoelectron spectroscopy analysis (by Atom %) of control carbon samples and carbon samples that have been microwave treated in accordance with the described methods. In the control sample, the percentage of carbon was 94.7, and oxygen was 5.3. In the two microwave-treated samples, the reduction in oxygen was dramatic (reduced to 1.5%), and treatment temperature (600° C. vs. 1000° C.) did not appear to make a difference.

FIG. 5B shows the relative quantities of the most probable carbon species as determined by X-ray photoelectron spectroscopy high-energy resolution (C1s Region (Atom %)). The oxygen-containing species were decreased in the microwave-treated samples, with carbon-carbon double bond species increased in the carbon sample treated at 1000° C. FIG. 5C shows the relative quantities of hydroxyl and ether linkages present in the control and the microwave-treated carbon samples. Note that the reactive hydroxyl groups are decreased in the microwave-treated carbon samples.

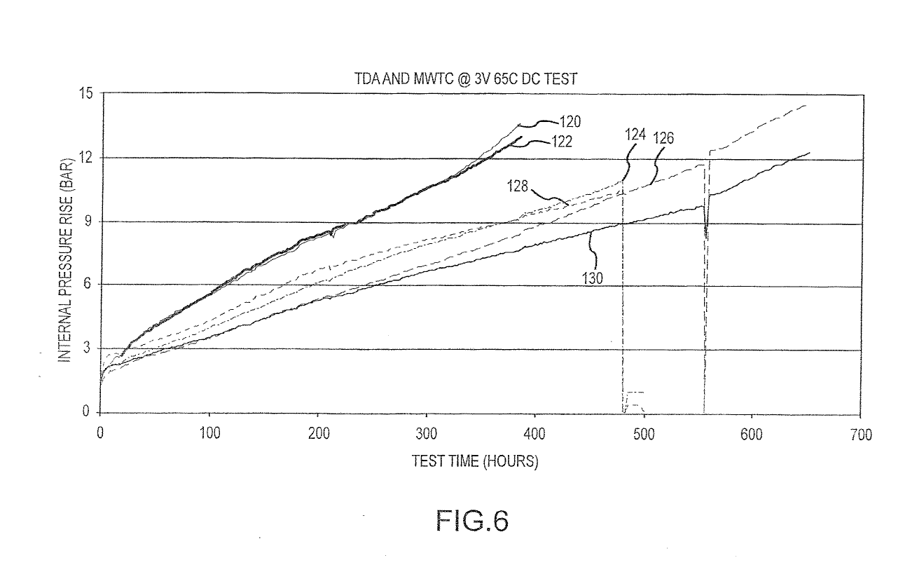

FIG. 6 is a graph of the comparative internal pressure rise in microwave-treated and -untreated carbon samples as a function of time. Microwave-treated carbon samples and controls were formulated with carbon black and PTFE. The powder was calendered into a film, then laminated to aluminum foil. The electrodes were then wound into 2600 F ultracapacitor cells. The cells were then fitted with transducers, placed in an oven at 65° C. with a constant voltage of 3.0 V. The pressure rise with time was monitored and compared to cells prepared from untreated carbon and for capacitors built with ultra-pure, non-commercially available carbon. The pressure rise for the capacitor made with the ultra-pure, non-commercially available carbon was accelerated as shown by lines 120 and 122. However, the pressure rise for the microwave-treated samples shown by lines 124 and 126 was the same as for the untreated controls shown by lines 128 and 130. These results indicate that microwave-treating carbon samples does not have an adverse impact on internal pressure of the capacitor.

Each practical and novel combination of elements and alternatives described herein, and each practical combination of equivalents to such elements, is contemplated as an embodiment of the present disclosure. Because more element combinations are contemplated as embodiments of the disclosure than can be explicitly enumerated herein, the scope of the disclosure is properly defined by the appended claims. All variations coming within the meaning and range of equivalency of the various claim elements are embraced within the scope of the corresponding claim. Each claim set forth below is intended to encompass any system or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art.

I claim:

1. A method of making treated carbon, the method comprising:
providing a carbon sample;
flowing a reactant gas over the carbon sample;
heating the carbon sample to at least 300° C.; and
targeting the carbon sample with microwave energy at or about ambient pressure or greater.

2. The method of claim 1, wherein the reactant gas comprises hydrogen and nitrogen.

3. The method of claim 2, wherein the percentage of hydrogen in the reactant gas is between 1% and 20%.

4. The method of claim 3, wherein the percentage of hydrogen in the reactant gas is between 3% and 10%.

5. The method of claim 4, wherein the percentage of hydrogen in the reactant gas is between 4% and 8%.

6. The method of claim 2, wherein the reactant gas further comprises at least one of the group consisting of methane, ammonia, and syngas.

7. The method of claim 1, wherein the reactant gas is provided in a continuous flow stream.

8. The method of claim 1, wherein the carbon sample is heated to at least 500° C.

9. The method of claim 8, wherein the carbon sample is heated to at least 600° C.

10. The method of claim 1, wherein the exposing step lasts for less than 30 minutes.

11. The method of claim 1, wherein the exposing step lasts for less than about 5 minutes.

12. The method of claim 1, wherein the microwave energy is supplied at a frequency of at least 0.3 GHz, with frequencies centered around about 0.915, 2.45, 5.80 or 22.0 GHz.

13. The method of claim 1, where the carbon sample is degassed before the flowing, heating and exposing steps.

14. The method of claim 13, wherein the degassing step is performed at between about 80 and 200° C.

15. The method of claim 14, wherein the degassing step is performed at between about 100 and 150° C.

16. The method of claim 13, where the degassing step is performed in a nitrogen gas environment.

17. The method of claim 13, where the degassing step is performed at about 28 inches Hg vacuum.

18. The method of claim 1, further comprising flowing non-reactive gas along with the reactant gas over the carbon sample.

19. A system for modifying carbon material at or about ambient pressure or greater, comprising:
a reaction chamber;
a heating element configured to heat the chamber to more than 300° C.;
a gas inlet configured to receive a gas flow and direct the gas flow to the chamber; and
a microwave source.

20. An electrochemical double layer capacitor comprising:
a first electrode;
a second electrode;
a porous separator disposed between the first and second electrode;
a container; and
an electrolyte,
wherein the first and second electrode comprise treated carbon formed by providing a carbon sample; flowing a reactant gas over the carbon sample; heating the carbon sample to at least 300° C.; and targeting the carbon sample with microwave energy at or about ambient pressure or greater.

21. A treated carbon with reduced oxygen-containing functional groups formed by:
providing a carbon sample;
flowing a reactant gas over the sample;
heating the carbon sample to at least 300° C.; and
targeting the carbon sample with microwave energy at or about ambient pressure or greater.

22. The treated carbon of claim 21, wherein the functional groups are reduced by more than 50%.

23. The treated carbon of claim 22, wherein the functional groups are reduced by more than 80%.

24. A method of making treated carbon, the method comprising:
providing a carbon sample;
flowing a reactant gas comprising N₂ and 5-10% H₂ over the carbon sample;
heating the carbon sample to at least about 600° C.; and
targeting the carbon sample with microwave energy at or about ambient pressure or greater.

25. The method of claim 24, where the carbon sample is degassed in an N₂ environment at 100-150° C. before the flowing, heating and exposing steps.
